(19) United States
(12) Patent Application Publication
(10) Pub. No.: US 2009/0323115 A1
(43) Pub. Date: Dec. 31, 2009

(54) SCAN-TO-EMAIL WITH EXPORT LIMITATIONS

(75) Inventors: Erik L.G.A. VAN BERGEN, Venlo (NL); Robert G.H. LIND, Sint Odilienberg (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 12/551,964

(22) Filed: Sep. 1, 2009

Related U.S. Application Data
(63) Continuation of application No. PCT/EP2008/051935, filed on Feb. 18, 2008.

(30) Foreign Application Priority Data
Mar. 2, 2007 (EP) 07103414.4

(51) Int. Cl. G06F 3/12; G06F 15/16

(52) U.S. Cl. 358/1.15; 709/206

(57) ABSTRACT

A scan-to-email function in a networked scanner device checks a destination email address entered by the user at the local user interface of the scanner against pre-programmed criteria for allowed email addresses. If the destination email address does not fulfil the criteria, the scan-to-email process is automatically stopped.

### CROSS-REFERENCE TO RELATED APPLICATIONS

This application is a Continuation of copending PCT International Application No. PCT/EP2008/051935 filed on Feb. 18, 2008, which designated the United States, and on which priority is claimed under 35 U.S.C. § 120. PCT International Application No. PCT/EP2008/051935 claims priority to Application No. 07103414.4, filed in Europe on Mar. 2, 2007. The entire contents of each of the above-identified applications are hereby incorporated by reference.

### BACKGROUND OF THE INVENTION

1. Field of the Invention:

The present invention relates generally to devices incorporating a scan-to-email function, and more particularly to the management of email destinations used for that function.

2. Description of Background Art:

Home office, small business, and enterprise office devices are consistently incorporating new functions. For example, multi-functional peripheral (MFP) devices are configured to perform various tasks, such as printing, copying, scanning, and faxing. More recently, these multi-function devices have added email functionality, which allows end-users to email directly from a scanning device a copy of an image file representing a scanned document. Thus, the scan-to-email function may be implemented in devices traditionally incorporating an optical scanner such as a copier, scanner, facsimile, or the aforementioned MFP devices.

Although most scanner/MFP devices are provided with a number keypad only, some of these devices are now being provided with a full alphanumeric keyboard which facilitates easy entry of destination email addresses. This may take the form of a hardware keyboard or an interactive keyboard image on a touch-sensitive display in the operating panel.

However, in this situation, it becomes quite easy to scan documents and send their images to any email recipient in the world. This gives reason for concern that information, which is intended for internal use only, is diffused to the outer world unnoticedly.

Therefore, there has grown a demand for means to control the outgoing email traffic, and more in particular to keep emails carrying scanned document images as an attachment from being spread unlimitedly.

### SUMMARY OF THE INVENTION

In order to fulfil this demand, the present invention proposes a method of controlling a scan-to-email function in a scanner device having a local user interface and a network connection to an email system, the method comprising:

receiving a destination email address entered by a user through the local user interface;

checking the received destination email address against pre-programmed criteria for allowed email addresses; and

deciding if the received address is an allowed address, and, if so, performing a related scan-to-email process, and if not, declining to do so and informing the user of the situation.

According to the present invention, a scanner device with email functionality is provided with a function to check the destination email address against pre-programmed criteria. Based on this evaluation, the function decides, if it is an allowed address and if it is, it allows the email with the scanned image to be sent, otherwise it prevents sending the email.

One way of evaluating the destination email address is checking the (domain.top-level domain) combination (the part behind the @ sign) in the address, and only allow certain combinations or even only one.

Other criteria may be one or more lists of allowed email addresses, or certain physical locations, based on a database of user information, such as the database of an LDAP server.

The present invention is also directed to a scanner device implementing the method according to the present invention and to an image server implementing a scan-to-file process in cooperation with a scanner device, and equally implementing the method according to the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a networked system wherein the present invention is practiced;

FIG. 2 schematically depicts the components of the system as seen from a scanner device;

FIG. 3 shows a scanner operating panel;

FIGS. 4 and 5 show dialogue display images as used for the present invention;

FIG. 6 is a flow chart of the major steps of the process according to the present invention; and

FIG. 7 shows an alternative implementation used for the present invention.

### DETAILED DESCRIPTION OF THE PREFERRED EMBODIMENTS

The present invention will now be described with reference to the accompanying drawings, wherein the same reference numerals have been used to identify the same or similar elements throughout the several views.

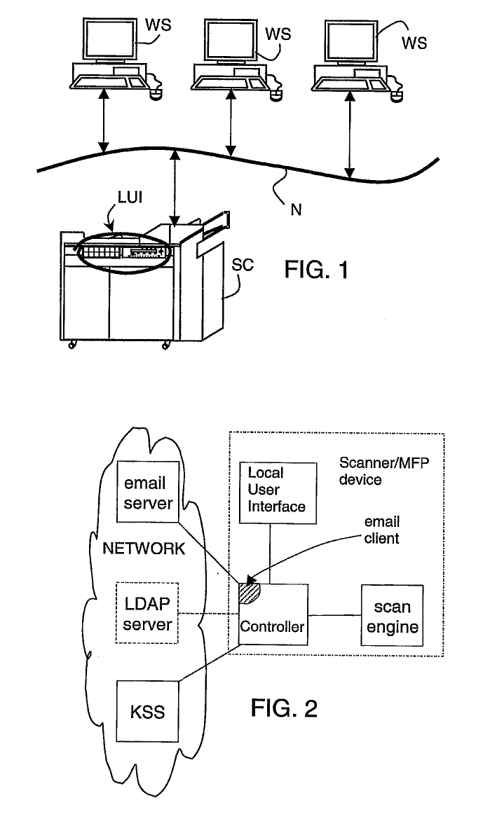

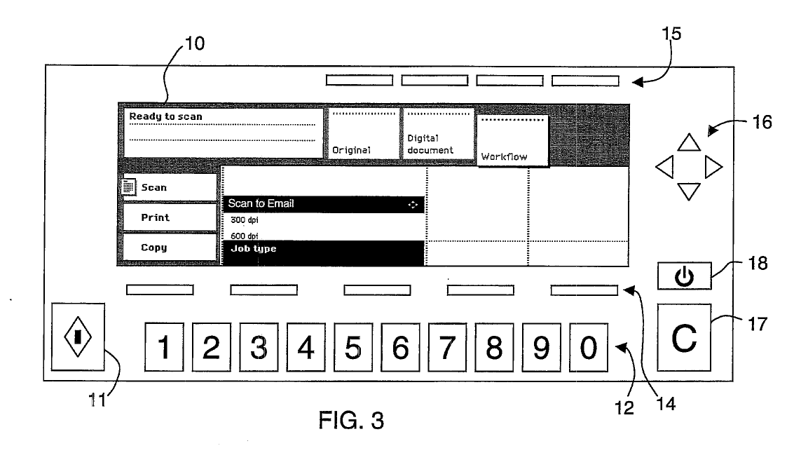

As shown in FIG. 1, a system incorporating the present invention includes a plurality of user workstations WS and at least one scanner device SC having a Controller and a local user interface (LUI), all of them interconnected by a digital network N, such as, e.g., a local area network or the internet. The scanner device may be part of an MFP device. In the embodiment of FIG. 1, the LUI includes an operating panel 1 (further described with reference to FIG. 3) and a full alphanumeric keyboard 2.

FIG. 2 depicts the components of the system as seen from a scanner device, including a Controller, a local user interface, a scan engine, a KSS web-browser, an LDAP server and an email server.

In the context of scan-to-email behavior, these components are described shortly below.

Scan engine: scans sheets of paper from an ADF (automatic document feeder) and/or glass platen, performs image processing and delivers bitmap images to the Controller.

Local User Interface (LUI): provides access to the system for the user to select the scan-to-email function and enter the email address of the recipient or, as the case may be, a code that identifies the email address of the recipient. The LUI may include a display, function keys and a full keyboard or a number-only key arrangement.

email server: takes care of the dispatch of email data to the specified email address. The system will use this server for sending only. An organization normally has only one email server, so multiple device Controllers may connect to the same email server.

LDAP server: allows the system to search for user information such as telephone number, location and email address of the recipient. In general an LDAP server stores individual information of members of the organization. An organization will normally have one LDAP server so multiple device Controllers may connect to the same LDAP server. Alternatively, the relevant information may also be locally stored in a (comma-separated) list or database in the Controller.

An LDAP server connection is not necessary for all implementations of the scan-to-email function. If the implementation requires the user to enter complete email addresses through a complete keyboard, or if a local database is used, it may be dispensed with, but it may also be used to deliver additional information, such as location, group memberships, etc.

KSS (Key Operator and System Administrator Service): provides access to the system for the Key Operator and System Administrator to respectively manipulate the job queue and monitor the latest status, and to configure the email client, address mapping (LDAP/list) and test functionality.

(device) Controller: communicates with the scan engine, creates digital documents from the scanned data, checks the recipient address and includes an email client for sending an email with the digital document attached.

A typical LUI operating panel of a scanner embodiment including the present invention is shown in FIG. 3. It includes a display screen 10, such as an LCD, and a number of keys, namely a START key 11, number keys 12, soft keys 14, index keys 15 (which are also soft keys), a star key cluster 16, a CANCEL key 17 and a STOP key 18. The operating panel may further include a full alphanumeric keyboard, as is shown in FIG. 1 (item 2).

In operation, the display screen 10 displays an image formed by a number of columns each situated above one of the soft keys 14. Each column relates to a specific basic function of the machine and shows the different possible settings of that basic function. For instance, the leftmost column is allocated to the selection between the so-called operating functions, namely the copying function, the printing function and the scanning function of the machine. The setting selected, in this case the scanning function, is denoted by a marker, in this example an icon depicting a document image, or otherwise, for instance reverse video. In addition, the setting selected for the leftmost column determines the contents of the other columns, because each operating function has its own relevant basic functions.

By operating one of the soft keys 14 the operator can select the relevant basic function and one of the possible different settings thereof, either by repeatedly pressing the key, in which case the list of settings is stepped through cyclically, or by operating the star keys 16.

The index keys 15 offer the option of calling up a different set of basic functions. The set selected is shown as being displaced. Thus, in FIG. 3, the work flow function is selected. The sets of functions tied to the index keys is dependent on the selected operating function, while the basic functions selectable with the soft keys 14 is in turn dependent on the selected index key.

In the example of FIG. 3, the “scanning” operating function has been selected, and the active index keys refer to:

“original”—the properties (size, reading direction, etc.) of the document to be scanned;

“digital document”—the properties of the scanning process itself (enlargement, image quality, etc.) as well as those of the output document description (size, reading direction, etc.); and

“workflow”—a set of preprogrammed job types, the “Scan to Email” being selected.

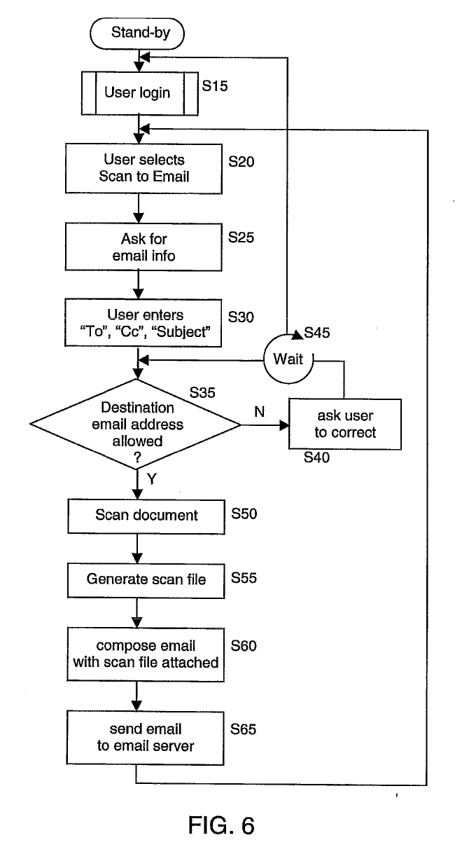

FIG. 6 shows a flow chart of a typical scan-to-email process.

The user walks to the scanner (MFP) device and identifies himself to the device using the LUI (S15). This may be done in one of several ways, depending on the hardware and software present in the device.

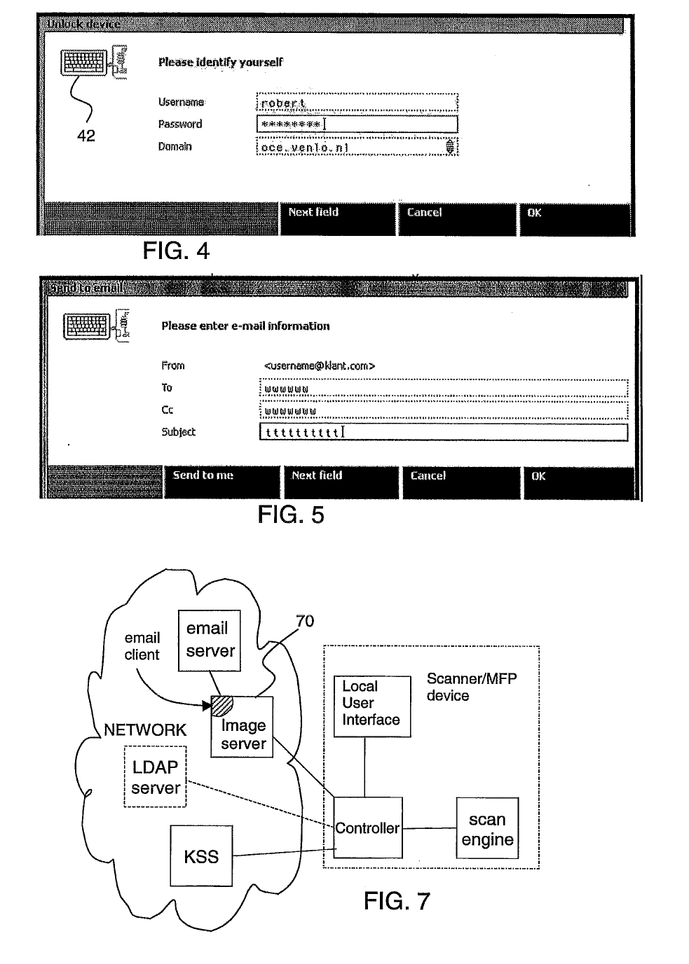

One way is by a network logon procedure as for instance facilitated by Integrated Windows Authentication, i.e. by entering username, password and (optionally) domain, as shown in FIG. 4, which shows a display image on the display 10 in FIG. 3. The keyboard icon 42 in the upper left corner of the display image indicates that entry via the keyboard is required. As generally known, log-in and log-out attempts are automatically logged when using IWA.

Another way of user identification/authentication is by putting a finger on a fingerprint scanner. The device controller compares the fingerprint scan image with a set of stored patterns in order to positively identify the user.

Yet another way is by entering user information such as telephone number, employee number or the like through the LUI keypad or keyboard and automatic look-up of the user name in the LDAP server or a local list (database), if present.

The device controller may then check if the user is authorized to use the device.

After his identification/authentication, the user puts the original documents to be scanned into the document input (automatic document feeder ADF or glass platen) and selects the scan-to-email function (S20).

In reaction, the device now asks (S25) the user through the LUI display to enter email information such as the recipient's email address, an optional Cc-address and a “subject” string as shown in the display image in FIG. 5 (it will be clear that the character strings in FIG. 5 are only indicative of text entry).

As the user name is already known from the logon procedure, this has been filled in automatically (the email bears the email address of the user as sender information). Alternatively, a device-id may be used as sender information.

The user enters the required information using the keyboard (S30) and confirms his input by pressing the function key (14) below the “OK” field in the display image or by hitting the START button 11 on the LUI panel.

When the user wants to send the email to himself, he can use the shortcut key below the “Send to me” field.

The device controller then checks if the recipient's email address entered by the user is an allowed one (S35). If it is, it starts scanning the original documents (S50).

If it is not, the user is informed of the situation and asked to correct the entered address (S40).

After a time-out without new user input, the device controller cancels the process and goes (back) to a stand-by mode (S45).

After completing the scan process, the device controller generates a scan file with an automatically formed file name (S55), composes an email message and attaches the scan file to it (S60). Then, it transfers the complete message to the email server through its email client (S65), whereupon the email message with the attachment is delivered to the recipient.

In a preferred embodiment, the scan file is given a file name based on the “Subject” string entered by the user for easy recognition, e.g. the “Subject” string itself. The scan file may be a PDF, TIFF, JPEG or other file format. The actual format may be selectable for the user with an entry on the LUI panel (not shown in the drawings).

Further functionality that adds to the convenience of the user is an “auto-complete” function, such as, if the allowed destination email addresses are all in a single (domain.top-level domain) combination, that combination. In that case, the address string will automatically be completed upon the user pressing the “@” key. Or, the address is automatically completed as soon as the controller recognizes a name during the input.

Further, a pre-defined group of users may be selected at once using an alias.

The Key Operator of the device or the System Administrator may be given the authority to configure the security level by defining the criteria for allowing email address selection.

In a particular embodiment, three security levels may be selectable (it being understood that other implementations may be contemplated by the skilled person, and are considered to be within the scope of the present invention):

1. Scan to everyone: every e-mail address typed in at the keyboard will be accepted;

2. Scan to selected group: emailing the scan file possible to a pre-defined group only, such as top-level domains and domains, example: “@oce.com,” or “@microsoft.com”; and

3. Scan to me: emailing the scan file only possible to scan to the user himself.

The limitation to a pre-defined group of users/email addresses may also comprise:

1. an explicitly listed group of email addresses;

2. a group defined by the location of the users, e.g., a particular building, or a site such as an R&D complex of labs, etc. The location of the users may be provided by the LDAP server or some other database;

3. a working group within a larger community. Again, group membership may be checked by consulting a database; and

4. other group definitions will be contemplated by the skilled person, depending on the actual situation.

The actual group limitation may be configured in the Controller by the Key Operator or the System Administrator. Alternatively or additionally, the group limitation may also be configured in the email server, in which case it would be necessary let the server know that the email originates from the scanner device.

### Alternative Form of Scan-to-Email Session

Instead of user identification/authentication at the very start of (any) use of the device, the device may be open for use by unidentified users and only ask for an identification at start of the scan-to-email session.

In this way, normal copy jobs may be done by anyone.

### Alternative Embodiment of the System According to the Present Invention

FIG. 7 shows an alternative system composition for working the present invention. This system is described in Applicant's U.S. Pat. No. 7,215,434, which is incorporated herein by reference.

In this system embodiment, the device Controller does not itself include an email client, but is connected via the network to an Image server 70 that functions as a destination for scan files for multiple further processing functions, including scan-to-email, but also scan-to-database, scan-to-fax, etc.

Any of the processing functions may be selected by a user on the operating panel of the scanner/MFP device, using the “Workflow” selection mechanism shown in FIG. 3.

Upon selection of the “Scan to Email” option, the device asks, through the LUI display, for an email address to send the scan file to, which may be, but does not have to be, the email address of the user himself.

Then, a scan is made and a scan file composed and metadata are added, possibly in the file name of the scan file, designating the file as a scan file for emailing to an equally included email address. The complete file is then transferred to the Image server, which checks the email address in accordance with the present invention. If the email address is allowable, the Image server composes an email, attaches the scan file to it and sends it to the email server. If it is not, the server declines to send the email. Instead, an error message is sent to the scanner device for display on the LUI display thereof. Additionally, it may send an email without the scan file, and explaining why the file is not attached to the relevant email address.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of controlling a scan-to-email function in a scanner device having a local user interface and a network connection to an email system, the method comprising:
receiving a destination email address entered by a user through the local user interface;
checking the received destination email address against pre-programmed criteria for allowed email addresses; and
deciding if the received address is an allowed address, and, if so, performing a related scan-to-email process, and if not, declining to do so and informing the user of the situation.

2. The method according to claim 1, wherein the step of checking further comprises checking a pre-defined part of the received email address for accordance with any of at least one address element defined as allowed in said pre-defined criteria.

3. The method according to claim 2, wherein the step of checking further comprises checking a domain.top-level domain combination in the received email address against said pre-defined criteria.

4. The method according to claim 1, further comprising the step of basing said pre-programmed criteria for allowed email addresses on a pre-defined physical location.

5. The method according to claim 1, further comprising the step of basing said pre-programmed criteria for allowed email addresses on a pre-defined group of users.

6. A scanner device having a local user interface and a network connection to an email system for implementing a scan-to-email function, said scanner comprising:
a device that receives a destination email address entered by a user through the local user interface;
a device that checks the received destination email address against pre-programmed criteria for allowed email addresses; and
a device that decides if the received address is an allowed address,
wherein the scanner device performs a related scan-to-email process if the received address is an allowed address, and declines to perform said related scan-to-email process if the received address is not an allowed address, the scanner device informing the user of the situation.

7. An image server connected to a scanner device having a local user interface and a network connection to an email system for implementing a scan-to-email function, wherein the scanner device scans a document and sends a scan file generated in the process to the image server together with a destination email address for sending the scan file to that address by email, said destination email address having been entered by a user through the local user interface of the scanner device, said image server comprising:
a device that checks the received destination email address against pre-programmed criteria for allowed email addresses; and
a device that decides if the received address is an allowed address, and, if so, sending the scan file to that address by email, and if not, declining to do so while informing the user of the situation.
